(19) United States
(12) Patent Application Publication
(10) Pub. No.: US 2016/0359953 A1
(43) Pub. Date: Dec. 8, 2016

(54) MIGRATION ENHANCED BY PRESENCE, INSTANT MESSAGING, AND LAST LOG-ON TIME

(71) Applicant: Dell Software Inc., Round Rock, TX (US)

(72) Inventors: Lars James Lervik, Madison, WI (US); Steven Allen Moore, Verona, WI (US)

(21) Appl. No.: 14/731,271

(22) Filed: Jun. 4, 2015

(51) Int. Cl. H04L 29/08; H04L 12/58

(52) U.S. Cl. CPC H04L 67/10; H04L 51/36; H04L 67/22

(57) ABSTRACT

A method for enhancing data migration via a Migration Manager is described. The method includes evaluating activity data corresponding to a particular set of data or a particular source device subject to data migration in order to determine whether a scheduled data migration can be performed. If the particular set of data or particular source device is currently being used, the scheduled data migration can be rescheduled. In other embodiments, the activity data can also be used to automatically schedule data migrations via the Migration Manager.

### BACKGROUND OF THE INVENTION

1. Field of Invention

The present invention generally relates to data migration. More specifically, the present invention relates to enhancing migration based on detected presence, instant message, and last log-on time.

2. Description of the Related Art

Data migration can be viewed as a process for transferring data between one or more computer systems and storage devices. Data migration may be performed for several reasons including providing backup copy of the data and consolidating data over different systems and devices into one central location. Data migration may also be performed to provide information from one computer system to a new computer system so that the new computer system also has access to the migrated data.

Generally, data migration is performed through the use of a processor and corresponding data migration software run on the processor. The data migration software allows the data migration to be performed in an automated fashion. To achieve an effective data migration, the data migration software also maps between locations where the data is originally stored (e.g., a source system) and where the data will be written (e.g., a target system). The data migration software further evaluates the format of the data being extracted from its original storage location (e.g., the source system) and a requested format of the data corresponding to the location where the data will be written to (e.g., the target system).

Data migrations may be scheduled in advanced to ensure that the source system and/or data to be extracted are available (and not in use) during performance of the data migration. For example, data migrations may require that the user is not currently logged onto their source system, require that the user have certain applications closed, or have the user perform some action to initiate the data migration. The user may also be required to have the source system connected to the network (e.g., work network) where the data migration will be performed. Use of the source system and/or data during the performance of data migration may negatively impact the migration. For example, the data migration may be performed at a slower rate, may be prone to inaccuracies or corruption, or may even be unable to carried out at all.

Although the scheduling can attempt to take into account the work schedules of the users and the availability of the source system and/or data, there may be many factors that can complicate whether a schedule is appropriate. For example, a business may be distributed across many time zones so migration of employee data based on work schedules may differ. The schedules for the employees may also vary unexpectedly (e.g., over time, sick days). Employees may also forget that data migration may be performed and utilize the source system and/or data. In any case, scheduling and ensuring that the data migration of multiple different sources can be difficult and uncertain. There is a need for improved Migration Manager systems and methods to ensure that data migration can be performed without interference from the user.

### SUMMARY OF THE CLAIMED INVENTION

A method for enhancing data migration via a Migration Manager is claimed. The method includes first retrieving activity data associated with to a particular set of data or a particular source device subject to data migration. The activity data can then be evaluated in order to determine whether a scheduled data migration can be performed. If the particular set of data or particular source device is currently being used, the scheduled data migration can be rescheduled.

A system for enhanced data migration is also claimed. The system includes a Migration Manager that retrieves activity data associated with to a particular set of data or a particular source device subject to data migration. The activity data can then be evaluated in order to determine whether a scheduled data migration can be performed. If the particular set of data or particular source device is currently being used, the scheduled data migration can be rescheduled.

### BRIEF DESCRIPTION OF THE DRAWINGS

FIG. 1 illustrates a system for data migration between various computing devices and storage using the Migration Manager.

FIG. 2 illustrates a flowchart describing steps performed during data migration.

FIG. 3 illustrates a system where the Migration Manager evaluates presence, last log-on time, and instant messaging data to ensure better data migration for the system.

FIG. 4 illustrates a flowchart describing steps performed for better data migration enhanced by presence, last log-on time, and instant messaging data.

### DETAILED DESCRIPTION

The systems and methods described herein are directed towards data migration over a network. More specifically, the systems and methods are directed towards a Migration Manager that is capable of ensuring better data migration for a particular source over the network. Simultaneous use of the source and/or data during data migration may negatively affect the process and accuracy of the migration to the target system, presence, last log-on time, and instant messaging data can be used to determine whether data migration can be currently performed. The Migration Manager can ensure that that the source and/or data to be migrated are not currently being used by the user. In other embodiments, the same information may also be helpful in tentatively scheduling data migrations.

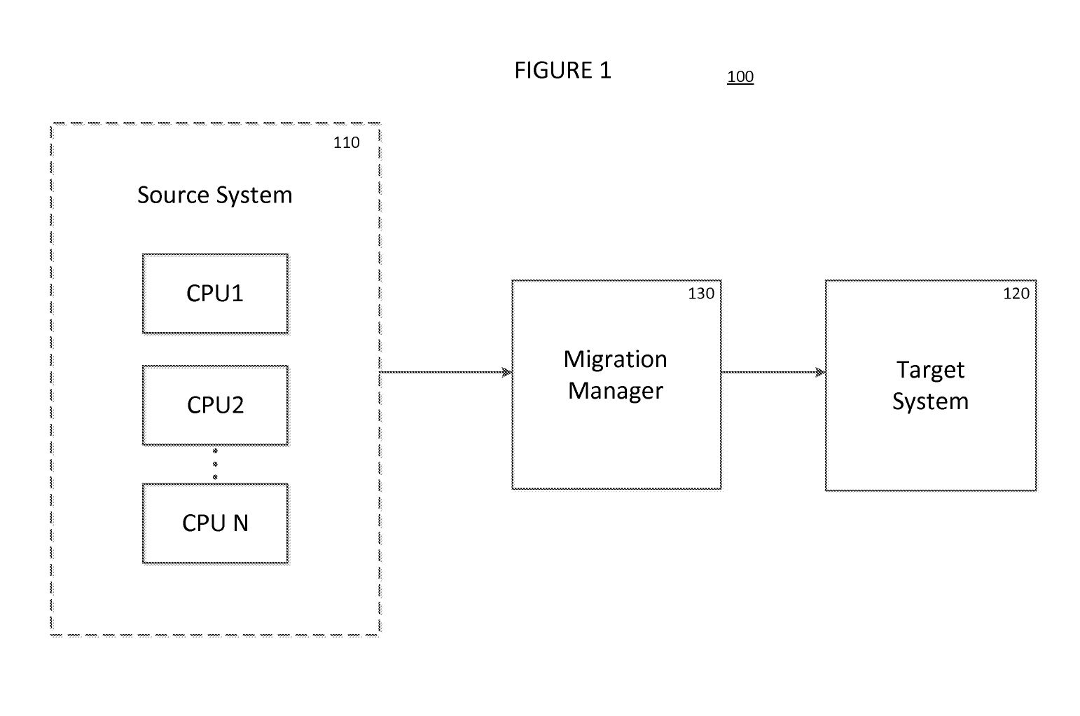

FIG. 1 illustrates a system 100 for data migration between a source system 110 and a target system 120. The source system 110 may include one or more sources such as computing devices (e.g., laptop, desktop, mobile device). The source system 110 may have various types of data stored locally in memory associated with each computing device. For example, the data (e.g., PST data) may be associated with an application (e.g., e-mail) stored on the computing device. The data stored in the source system 110 can be selected for migration from the source system 110 to the target system 120. In some cases, the data migration may occur at a pre-scheduled day and time to ensure that the data is available and not in use (e.g. after business hours).

The target system 120 may be a storage device or a server. The target system 120 can be used to store the data being migrated from the source system 110. Data migration may be performed for a variety of reasons. In some cases, data from the source system 110 may be stored on the target system 120 in order to provide a back-up copy of the data. The data can also be stored on the target system 120 in order to have all of a particular set of data in one common location.

In some embodiments, the target system 120 can also be another computing device. For example, a user may wish to migrate data stored in one computing device to another computing device (e.g., the target system 120). In this way, the data that was migration can also be used with the other computing device that was the target of the data migration. A user may wish, for example, that the archived mail stored in the first computing device be migrated to a second device. The data migration may also transfer archived mail between different types of devices, applications, and formats.

The system 100 performs the data migration between the source system 110 and the target system 120 by using a Migration Manager 130. As described herein, the Migration Manager can be viewed as a collection of different functionalities that all facilitate data migration. The Migration Manager 130 may be implemented as a computing device that includes its own processor and memory. The Migration Manager 130 can carry out scheduled data migrations based on instructions stored in memory of the Migration Manager 130. These instructions may include identifying the data to be migrated, from which sources the data is to be migrated, and the time when the data migration is to occur. In other embodiments, an administrator (e.g., an individual responsible for managing and operating the Migration Manager 130) may customize the characteristics of a data migration being carried out by the Migration Manager 130. In other words, the administrator is capable of inputting information identifying the data to be migrated, where the data may be located, and when the data migration should be performed. Further details for the various features and functionalities of the Migration Manager 130 are provided below.

As noted above, scheduling data migration may be customized to ensure that a particular source in the source system and/or data to be extracted is not being currently being used. For example, the scheduling may be structured after work hours when the source system and/or data are less likely to be in use. In some situations, an administrator in charge of the data migration may request from various users a period of time to perform data migration where one or more source systems and/or data will not be in use. By ensuring that either the source system and/or data is not being used during the performance of the data migration, the Migration Manager (or administrator) can lessen the likelihood that the data during migration becomes corrupted. In some cases, if the source system and/or data is in use, data migration for that particular source system and/or data may not be possible.

It should be noted that data migration may be performed with numerous different users simultaneously. The Migration Manager can obtain information from the various different users for available periods of time when data migration can be performed. The Migration Manager can schedule groups of users based on similar periods of time where data migration may be performed. It can be difficult for an administrator to manually communicate with and determine when each individual user is available and subsequently instruct the Migration Manager to perform the data migration that satisfies the time constraints for all the users in question. The Migration Manager can be instructed to obtain this information from the user in an automated fashion and subsequently schedule the data migrations based on the responses from the various users.

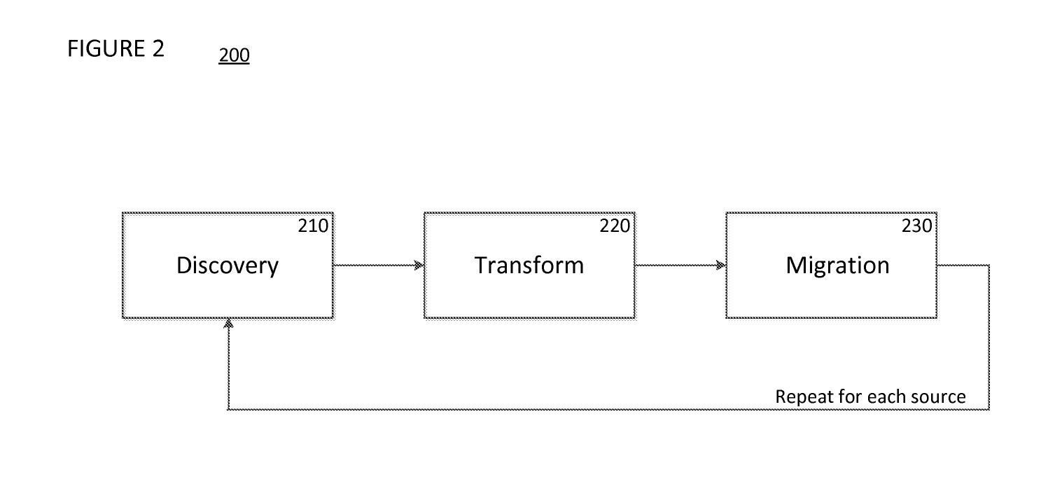

FIG. 2 illustrates a flowchart 200 describing exemplary steps performed during data migration. As noted above, data migration between the source system and the target system is performed by the Migration Manager.

Generally, the Migration Manager performs steps that fall under three broad classifications. First, the Migration Manager is instructed to discover the sets of data from one or more source systems to be migrated in step 210. This may include determining what data needs to be migrated and where the data is stored. The Migration Manager may be informed about such details (e.g., administrator identifies particular sets of data or users to migrate data from, the user identifies to the Migration Manager what data should be migrated). Second, the Migration Manager provides transformations. In particular, the transformations are used to format the data extracted from the source system to fit the format of the target system in step 220. Third, the Migration Manager extracts and subsequently writes the source data into the target system in step 230. The Migration Manager, during the data migration, may use any applicable transformation derived in step 220.

First, the Migration Manager is instructed to discover the sets of data from one or more source systems to be migrated in step 210. This may include determining what data needs to be migrated and where the data is stored within a particular source system. The Migration Manager may be informed about such details related to the data that needs to be migrated or where the data is stored (e.g., administrator identifies particular sets of data or users to migrate data from). Second, the Migration Manager provides transformations. In particular, the transformations are used to format the data extracted from the source system to fit (e.g., make compatible with) the format of the target system in step 220. Third, the Migration Manager extracts and subsequently writes the source data into the target system in step 230. The Migration Manager, during the data migration will use any applicable transformation derived in step 220.

It should be noted that the flowchart 200 illustrates one embodiment of the present invention. Within each step 210-230, there may be additional steps as described herein.

With respect to step 210, the Migration Manager may be instructed to locate a particular set of data stored in one or more source systems to be migrated to the target system. As indicated above, the Migration Manager may be provided information identifying what data is to be migrated and where the data might be found (e.g., user names and corresponding computing devices). The Migration Manager can then perform searches of all possible locations in the source system for the specified data to be migrated.

For example, data migrations may be directed towards migrating PSTs (i.e. personal storage tables). Generally, PSTs correspond to a file format (.pst) associated with Microsoft software (e.g., Microsoft Exchange Client, Windows Messaging, and Microsoft Outlook). The PSTs are used to store and archive copies of data (e.g., messages, calendar events) locally on a computer from which a user is utilizing the associated Microsoft software.

Although details will be provided towards an embodiment directed towards data migration of PSTs, it should be known in the art to apply the present application to other types of data that can be subject to data migration as well. The Migration Manager is capable of receiving and carrying out discovery of various types of data stored in the source system that one might want migrated to the target system.

In a possible scenario, a business may want to migrate PST data related to work email of all employees to the target system (e.g., Microsoft Office 365). As noted above, the data may be migrated in order to provide a backup copy for situations where the data could be lost (e.g., computing device failure) or to provide a centralized location where the PST data can be accessed from. In order to extract and store the PST data to the target system, the location where the PST data is stored needs to be identified.

To determine where the identified data to be migrated (e.g., PST data) is stored, the Migration Manager may first scan an Active Directory to identify applicable users. The Active Directory may be a list of users associated with a particular entity that is performing the data migration. For example, a business may have an Active Directory that includes the names of all the employees who work for the business. The Migration Manager can use the Active Directory to identify the employees who are subject to the data migration. If the Migration Manager is instructed to perform migration of data for only a subset of employees (e.g., particular department), the Active Directory can also be used to identify the particular subset of employees. In other embodiments, the Migration Manager may be provided the identities of the employees who the data migration may be performed for. For example, an administrator may indicate that John Doe's PST data should be migrated to the target system.

The Migration Manager also determines where the data for the identified employees is stored. By using the Active Directory to identify the set of applicable employees, the Migration Manager can then identify the various sources where the data to be migrated may be stored. For example, the Migration Manager may look for associated computing devices associated with each employee. These computing devices (e.g., desktop, laptop, mobile device) may be assigned to each employee for work-related functions. The Migration Manager can utilize the network of the business to determine which computing devices are available. Some computing device may be connected directly to the network associated with the business. In situations where an employee is working remotely, the working device may indirectly connect (e.g., Virtual Private Network) to the network associated with the business. In any case, the Migration Manager can search for the corresponding computing devices assigned to each employee so long as the computing device is somehow connected to the same business network. In scenarios where a computing device is known to exist for a particular employee but cannot be found, the Migration Manager may search for the computing device continually or at regular intervals until a period of time has elapsed.

Once the computing device has been located, the Migration Manager can then search the memory of each computing devices for the requested data to be migrated. With respect to the embodiment discussed above, the Migration Manager searches the memory of each computing device for the PST data. In other embodiments, the Migration Manager may also be instructed to look for more than just PST data.

The discovery step 210 is performed for each employee found on the Active Directory for which data migration is scheduled to be performed for. The number of employees in which discovery is performed for may vary based on the need of the business. In fact, the Migration Manager is capable of customization including identifying who the data migration is performed for and what set of data is being migrated. As noted above, the customization may be controlled by an administrator (e.g., an individual associated with the business tasked with managing and operating the Migration Manager).

Step 220 involves the Migration Manager providing a transformation that can be used during data migration. Generally, the Migration Manager evaluates the format of the data from the source system and the format requirements for the target system. In some situations, the format for the data stored in the source system and the format requirements for data to be stored in the target system are distinct. Therefore, to complete the data migration, the Migration Manager may need to provide transformations for source data from its original format into a format that is accepted by the target system. This transformation process involves obtaining proprietary information regarding data formats used by the source system and the target system. The information can then be used to provide a mapping or conversions between the two formats. These derived transformations in step 220 are later used during the actual migration of the data in step 230 below. These derived transformations may be stored in memory associated with the Migration Manager for future use with a particular source system-target system pairing.

In step 230, the data migration is performed by the Migration Manager. Generally, the Migration Manager extracts the particular data from the source system. The Migration Manager can first temporarily store the extracted data in memory associated with the Migration Manager. The Migration Manager can then perform any necessary transformations (derived above in step 220) related to the formatting of the extracted data to ensure that the data can be compatible when written into the target system. After the transformation has been performed on the data, the data is written into the target system. The extracted data that was temporarily stored in the Migration Manager can then be deleted to make room for additional data migrations.

In the embodiment described above, the PST data can be migrated from one or more sources to Microsoft Office 365, which is a hosted email server. As indicated above, data migration may be performed for various reasons including backing up the data (e.g., PST data). The PST data from the various source systems can also be all accumulated into one central location. The use of Microsoft Office 365 can also allow users to access their PST data remotely.

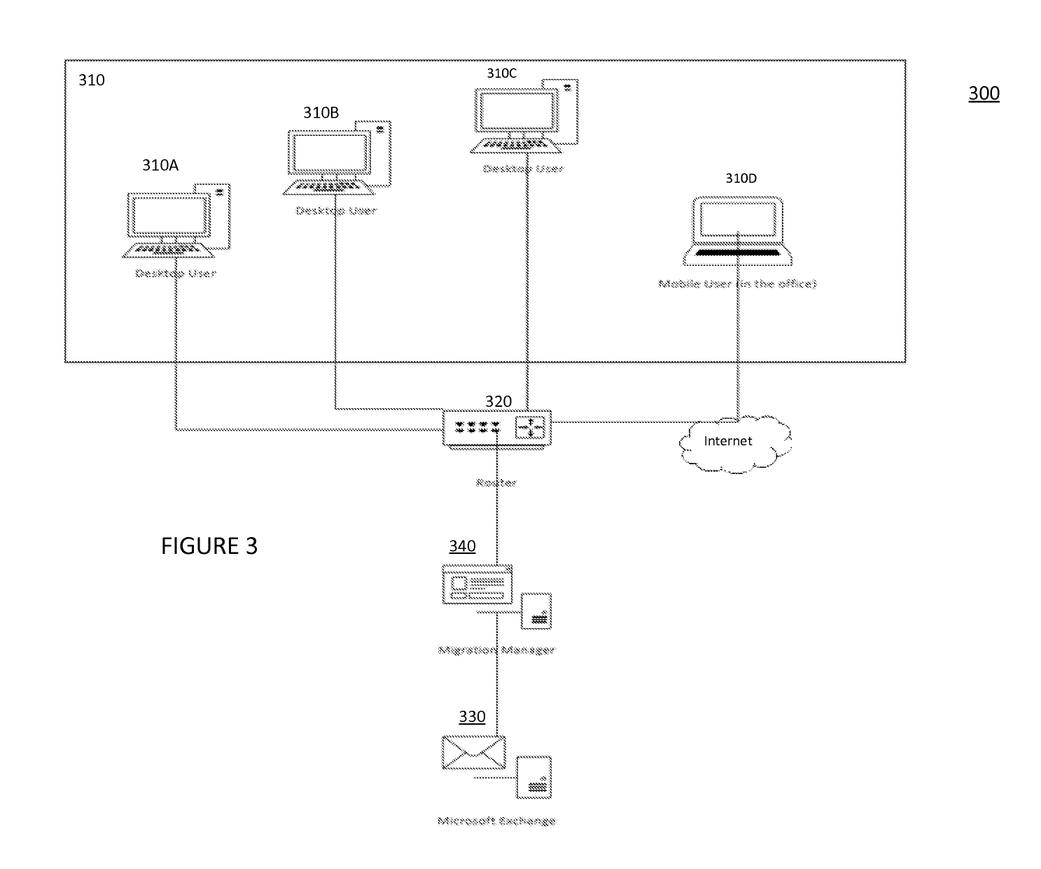

FIG. 3 illustrates a system 300 where the Migration Manager evaluates presence, last log-on time and instant messaging data to ensure better data migration for the system. As referenced above, there is a need to schedule when the data migration among one or more source systems should be performed. Generally, the source system or the data should not be in use to ensure that the data migration is performed as expected. Use of the source system and/or data during data migration may cause complications (e.g., data corruption) or even prevent the data migration from occurring in the first place. Therefore, embodiments of the present invention may include determining when an appropriate time to perform the data migration may be started. Further embodiments can also include ensuring that the source system and/or data subject to the data migration is not in use.

As illustrated in FIG. 3, there are a plurality of computing devices 310A-310D (e.g., desktop, mobile device) associated with the source system 310. In other embodiments, there may be more or less computing devices associated with the source system 310. These computing devices are all associated with the same network 320. The network 320 may be associated with an entity (e.g., company) where each of the users of the computing devices is employed at. The network 320 may have known properties/capabilities related to processes performed on the network 320 (e.g., bandwidth, speed).

Each of the computing devices 310A-310D may contain information that can be migrated to the target source 330 through the use of the Migration Manager 340. Based on the embodiment illustrated in FIG. 3, the target source 330 is a Microsoft Exchange server. It should be noted that in other embodiments, the target source 330 may be any system where data can be stored during data migration.

With each possible source 310A-310D, data migration can be performed to migrate data (or sub-sets of data) stored in a particular source to the target source 330 (e.g., Microsoft Exchange). Before data migration can be performed, however the Migration Manager 340 needs to schedule performance of the data migration for the possible sources 310A-310D.

The scheduling of the possible sources 310A-310D can be performed in a variety of different ways (and is the subject of the present invention). As noted above, the Migration Manager (and/or administrator) may be capable of contacting the various users associated with the possible sources 310A-310D in advance in order to figure out when data migration can be performed. By figuring out when a source is in use and/or not in use, the Migration Manager (and/or administrator) can schedule the data migration to occur accordingly. Since data migration may involve a large number of possible sources, however, the above method may not be efficient or even possible. For example, there may be hundreds of possible sources associated with a single business spanning multiple offices over different time zones. Furthermore, there is a possibility that unforeseen changes associated with the user regarding when the possible source and/or data may be used can also change. For example, the user may forget that the data migration may have been scheduled for a particular time. There may also be work-related reasons that require the user to use the possible source and/or data during a time that was previously scheduled for data migration. In any case, it may be difficult or even impossible (based on the prior art) that a Migration Manager can 1) schedule data migration for a plurality of different possible sources and/or data and 2) ensure that the data migration can be performed.

As described herein, the Migration Manager 340 is capable of utilizing a variety of different information associated with the possible source. For example, the Migration Manager 340 can schedule migration based on 1) presence data, 2) last log-on time data, and 3) instant messaging data. Further details regarding the implementation of the three different types of data described are provided below. It should be noted, however, that other methods capable of analyzing availability of a possible source and/or data may also be possible. In some embodiments, groups of possible sources can be scheduled for data migration within the same span of time whereby a particular group of possible sources may have similar availabilities when the data migration can be performed.

Presence data pertains to a status of a particular possible source and whether the possible source is in use. In particular, the presence data can indicate whether the user associated with the possible source is currently using the possible source. The presence data can be obtained, for example, through evaluating the status of the user (e.g., currently logged on or logged off) when associated with an instant messaging application associated with the possible source. In some embodiments, the presence data may also be associated with user connection with the network associated with the business (and also used for the data migration). Generally, if the presence data indicates that the user is off-line (e.g., not using the possible source currently), this may be a favorable time period to perform data migration (e.g., the possible source and/or data is not in use). If the presence data indicates that the user is on-line, however, the Migration Manager 340 may reschedule data migration for another time. In some embodiments, the Migration Manager 340 may inform the user associated with the particular possible source and request further direction as to whether the data migration should be continued or reschedule.

The presence data may be obtained and evaluated for a period of time before a scheduled data migration is to be performed in order to ensure that the data migration can proceed as planned. In some embodiments, the presence data can also be used to schedule the data migration as well. The Migration Manager 340 may be capable of gathering presence data for the various possible sources over a period of time. The presence data can then be evaluated to determine if there are any patterns (e.g., trends) that may lend itself to inferring an available time period for data migration to be performed. For example, if presence data is collected for a particular possible source and it is found that the user associated with the possible source has never worked on the weekends, it may be possible that data migration can be scheduled for the next available weekend with some certainty that the possible source will be available for data migration at that time. In other words, work schedules associated with various users can be analyzed to evaluate when data migration can be performed. The work schedules may be tied to presence data since users may generally log onto the work network at the beginning of a work shift and log off when the user is at the end of a work shift.

The last log-on time data may also be used by the Migration Manager 340 to evaluate when data migration can be performed. Similar to the presence data, the last log-on time data may look at when the user associated with a possible source has logged off thereby inferring that the possible source is currently available for data migration. The Migration Manager 340 may evaluate patterns of last log-on time to determine if a pattern exists as to when the user logged off in order to schedule a data migration as well as to determine if data migration can begin.

It should be noted that the last log-on time data may also be used to evaluate which possible sources (or users associated with the source) are no longer active. For example, in the last log-on time data corresponds to a time period for more than a certain threshold (e.g., one month), it may infer that the previous user associated with the possible source may no longer be working at the company/business. In this way, the Migration Manager 340 can, for example, schedule similarly inactive sources for data migration within the same span of time.

In another embodiment, the Migration Manager 340 may also use the last log-on time data to determine whether or not data migration is necessary for a particular source. For example, the Migration Manager 340 may be capable of determining when a last data migration has occurred with respect to the last log-on time data. In a scenario where the last migration occurred after a last log-on associated with a particular source, it can be inferred that the source may not be currently used. Additionally, if a particular set of data is subject for data migration was previously migrated after the last log-on associated with the particular source, it can be inferred that no new data may be found on the source. In such a scenario, it may be possible to remove the particular source from the group of sources in which data migration is being scheduled for.

Instant messaging data can also be used by the Migration Manager 340 to schedule data migrations and to ensure that data migration can be carried out as scheduled. In a possible scenario, the Migration Manager 340 (or an administrator) may utilize instant message to contact the user associated with a particular source. The instant messaging can be used to interact with the user to inform the user that data migration may be performed shortly. It may be possible that the Migration Manager 340 (or administrator) can instruct the user to log-off or refrain from using particular sets of data that are subject to data migration.

The Migration Manager 340 (or administrator) may also be capable of requesting whether the scheduled data migration should be postponed. The user may be capable of informing the Migration Manager 340 (or administrator) whether data migration can be performed as scheduled or if there is another time that the data migration can be performed (e.g., 30 min later).

Instant messaging may also be used to provide a report of the data migration to the user after it has been completed by the Migration Manager 340. For example, the instant messaging can provide a report that includes details about the migration. Such details may include identifying any issues that may have occurred during migration, reasons for the identified issues, what data had been successfully migrated, and time of completion.

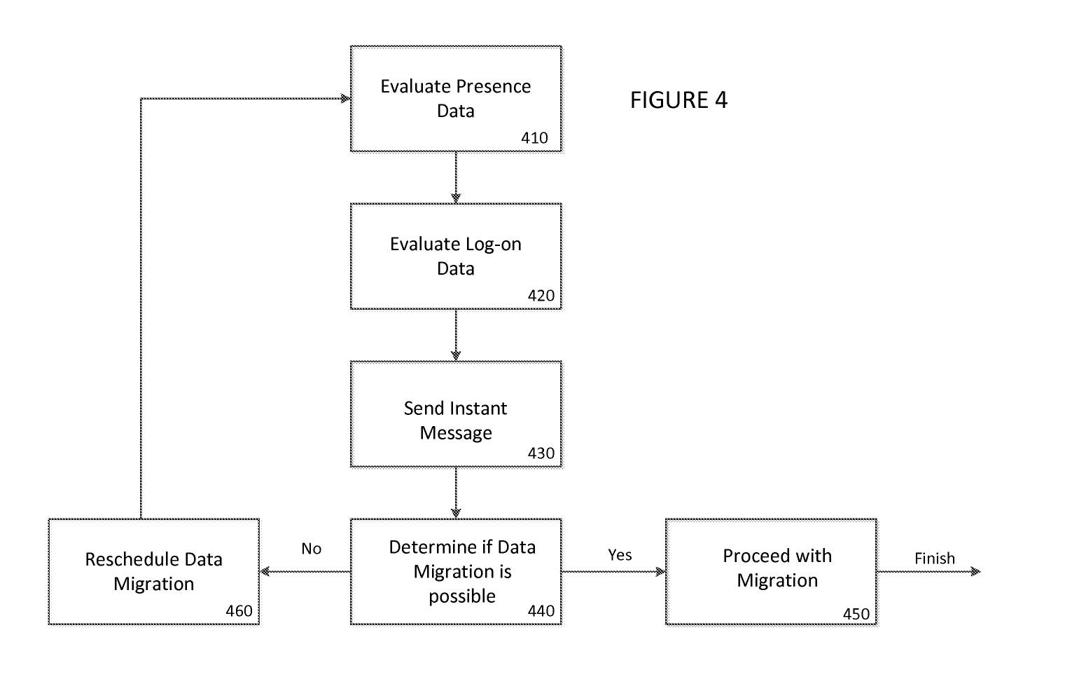

FIG. 4 illustrates a flowchart describing steps performed for better data migration enhanced by presence, last log-on time and instant messaging data. The steps facilitate a way for automatically scheduling data migration for a plurality of distinct source systems. The steps also facilitate automatically ensuring that the data migration can be performed. In situations where the source and/or data subject to data migration is currently being used, the steps can include re-scheduling the data migration for a later time.

In step 410, presence data for each possible source (e.g., computing device) can be evaluated. As described above, the presence data may infer user activity with a particular source. The presence data may be analyzed for any patterns that can be used to schedule a data migration. For example, if a user is generally inactive on the weekend (e.g., is not at work), the Migration Manager can attempt to schedule data migration associated with that particular source for a period of time within that window of time where the user is inactive.

The presence data can also be evaluated prior to performing data migration. The presence data can provide notification to the Migration Manager whether a user is active on the source and/or using data subject to a scheduled data migration. The Migration Manager can then reschedule the data migration for a later time. In some embodiments, the Migration Manager may inform the user of the scheduled migration and request further instructions as to whether the scheduled migration could proceed (in which case the user is instructed to log out or refrain from further use of the source and/or data) or if it should be postponed.

In step 420, log-on data for each possible source (e.g., computing device) can be evaluated. As described above, the log-on data may infer user activity with a particular source. The log-on data, similar to the presence data, may be analyzed for any patterns that can be used to schedule a data migration. For example, if a user generally logs onto their source (e.g., computing device) thereby connecting to the network associated with the company/business or logs off their source (e.g., after a work shift), the Migration Manager can attempt to schedule data migration associated with that particular source for a period of time within that window of time where the user is logged off.

The log-on data can also be evaluated prior to performing data migration. The log-on data can provide notification to the Migration Manager whether a user is currently logged onto the source. As noted above, users may forget that a scheduled data migration may occur or could end up working at different times than when is usually seen. In any case, the Migration Manager can reschedule the data migration for a later time if the log-on data determines that the user is currently using the source. In some embodiments, the Migration Manager may inform the user of the scheduled migration and request further instructions as to whether the scheduled migration could proceed (in which case the user is instructed to log out or refrain from further use of the source and/or data) or if the data migration should be postponed.

In step 430, instant messaging can be used to schedule and/or determine whether the data migration can be performed. In either case, the Migration Manager (or administrator) can send an instant message to a particular source. A user associated with the source can respond to the instant message. The instant message may include a request for a time frame when data migration can be performed. For example, the user may be provided with example times that can be selected (or alternatively the user can input a custom time) corresponding to a time where the user would not be utilizing the source and/or data subject to the data migration. The response to the instant message can be used by the Migration Manager in scheduling the source. In some embodiments, the Migration Manager can group multiple sources based on similar time frames in which data migration can be performed.

Prior to performing data migration, the Migration Manager may also send an instant message to the particular source to confirm that the source and/or data subject to data migration is not in use. The sending of an instant message may be triggered with detection of user activity associated with the source (e.g., presence data and/or log-on data). The instant message may include information informing the user of the scheduled data migration. The instant message may also include a request for the user indicating whether the data migration should be performed as scheduled or postponed. The user is capable of responding to the Migration Manager based on the preference of the user. If the user would like the data migration to be performed as scheduled, the user can inform the Migration Manager to proceed as scheduled. Instructions from the Migration Manager may be provided in response informing the user to refrain from using the source and/or data subject to the data migration. If the user would like the data migration to be postponed, the Migration Manager may request the user for the next available time that data migration can be performed instead. In some embodiments, the Migration Manager may automatically determine a next available time based on evaluation on user data (e.g., presence data, log-on data).

In step 440, determination as to whether data migration can be performed is processed based on the data evaluated in steps 410-430. Generally, the source and/or data subject to the data migration should not be in use to ensure that data corruption is minimized. In some cases, data migration may not be possible if the source and/or data subject to the data migration is currently in use. If the source and/or data subject to the data migration are determined not to be in use, the scheduled data migration can proceed as planned (step 450). If the source and/or data subject to the data migration, however, are determined to be in use by a user, the data migration can be re-scheduled (step 460).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for enhancing data migration via a migration manager, the method comprising:
retrieving activity data that corresponds to a specified set of data or a specified source device containing data to be migrated, wherein the activity data indicates whether the specified set of data or the specified source device is currently being used;
evaluating the activity data, wherein the evaluation determines whether the specified set of data or specified source device is currently being used; and
generating a notification to notify a user associated with the specified set of data or the specified source device that a scheduled data migration is about to be performed.

2. The method of claim 1, wherein the specified source device includes a computing device.

3. The method of claim 1, wherein the activity data includes presence data and log-on data, the presence data and log-on data indicative of user activity associated with the specified set of data or the specified source device.

4. The method of claim 1, further comprising transmitting the notification as an instant message to the specified source device, the instant message including a request for a response from the user about whether the scheduled data migration should be postponed.

5. The method of claim 4, further comprising receiving the response from the user indicating that the scheduled data migration should be postponed, wherein the migration manager re-schedules the data migration for a later time based on the response.

6. The method of claim 4, further comprising receiving the response from the user indicating that the scheduled data migration can proceed, wherein the migration manager based on the response:
informs the user to refrain from further use of the specified set of data or the specified source device subject to the data migration, and
performs the scheduled data migration with respect to the specified set of data or the specified source device.

7. The method of claim 1, wherein the steps of the method are performed simultaneously for a plurality of different source devices.

8. The method of claim 1, wherein the specified set of data subject to data migration includes PST data.

9. A system for enhancing data migration via a migration manager, the system comprising:
one or more source devices, the source devices containing data to be migrated; and
a migration manager, the migration manager including a processor that executes instructions stored in memory, the processor executes the instructions to:
retrieve activity data that corresponds to a specified set of data or a specified source device to be migrated, wherein the activity data indicates whether the specified set of data or the specified source device is currently being used;
evaluate the activity data, wherein the evaluation determines whether the specified set of data or specified source device is currently being used; and
generate a notification to notify a user associated with the specified set of data or the specified source device that a scheduled data migration is about to be performed.

10. The system of claim 9, wherein the one or more source devices include a computing device.

11. The system of claim 9, wherein the activity data includes presence data and log-on data, the presence data and log-on data indicative of user activity associated with the specified set of data or the specified source device.

12. The system of claim 9, wherein the migration manager further transmits the notification as an instant message to the specified source device, the instant message including a request for a response from the user about whether the scheduled data migration should be postponed

13. The system of claim 12, wherein the migration manager receives the response from the user indicating that the scheduled data migration should be postponed, and re-schedules the data migration for a later time based on the response.

14. The system of claim 12, wherein the migration manager receives the response from the user indicating that the scheduled data migration can proceed, and based on the response:
informs the user to refrain from further use of the specified set of data or the specified source device subject to the data migration, and
performs the scheduled data migration with respect to the specified set of data or the specified source device

15. The system of claim 9, wherein the instructions executed by the migration manager are performed simultaneously for a plurality of different source devices.

16. The system of claim 9, wherein the particular set of data subject to data migration includes PST data.
